(19) United States
(12) Patent Application Publication
(10) Pub. No.: US 2007/0210175 A1
(43) Pub. Date: Sep. 13, 2007

(54) SEMICONDUCTOR MEMORY CARD

(75) Inventor: Naohisa OKUMURA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/683,634

(22) Filed: Mar. 8, 2007

(30) Foreign Application Priority Data
Mar. 9, 2006 (JP) 2006-064327

(51) Int. Cl. G06K 19/06

(52) U.S. Cl. 235/492

(57) ABSTRACT

A semiconductor memory card that is connected to an external device for use, has a circuit board that has an input/output terminal to be connected to said external device for signal input/output, an internal terminal and a substrate wiring formed on the upper surface thereof and has a resin member for insulation protection of said substrate wiring; a semiconductor memory chip for storing data that is mounted on the lower surface of said circuit board and electrically connected to said internal terminal; and an insulating seal for insulating said internal terminal from the outside that is disposed on said circuit board to cover at least said internal terminal, wherein the peripheral part of said insulating seal is bonded to a position lower than the height of the upper surface of said resin member.

### CROSS-REFERENCE TO RELATED APPLICATIONS

This application is based upon and claims the benefit of priority from the prior Japanese Patent Application No. 2006-64327, filed on Mar. 9, 2006, the entire contents of which are incorporated herein by reference.

### BACKGROUND OF THE INVENTION

1. Field of the Invention

The present invention relates to a semiconductor memory card including a semiconductor memory chip.

2. Background Art

Semiconductor memory cards incorporating a semiconductor memory chip are widely used as a data storage medium for digital devices, such as digital video cameras, cellular phones and portable music players. Such a semiconductor memory card is inserted to a socket on an external digital device to access the circuit in the digital device for writing and reading data.

For example, a conventional semiconductor memory card has a base card having an opening in the top surface thereof, a semiconductor package that includes a semiconductor memory chip for storing desired data, has input/output terminals formed on the upper surface thereof to be electrically connected to the semiconductor memory chip and an external device for signal input/output, and is mounted in the base card in such a manner that the input/output terminals are exposed through the opening, and an adhesive label that is bonded on the upper portion of the base card and covers the semiconductor package in such a manner that at least a part of the input/output terminals are exposed (see Japanese Patent Laid-Open No. 2003-346109).

Such a structure prevents the semiconductor package from coming off the base card and contaminants and moisture from being introduced into the semiconductor package.

Furthermore, similarly, an insulating seal (label) is applied to internal terminals for writing a program to the semiconductor memory chip mounted in the assembly step of the semiconductor memory card or testing the mounted semiconductor memory chip for any failure after the test in the assembly step, for example. In this way, malfunction or the like of the semiconductor memory card is avoided by insulating the internal terminals, which are not used by users, from the outside.

However, according to the conventional technique described above, when the edge of the insulating seal comes into contact with the external device, the edge of the insulating seal on the semiconductor memory card may catch on the external device or the like. If this occurs, stress is concentrated at the bonded seal edge, and the seal may peel off. Thus, the internal terminals may be exposed at the part where the seal has peeled off.

Thus, there is a problem that, if terminals or the like of an external circuit comes into contact with the part where the seal has peeled off, an unwanted signal is input to the internal terminals to cause malfunction or the like of the semiconductor memory card, and thus, the reliability is lowered.

### SUMMARY OF THE INVENTION

According one aspect of the present invention, there is provided: A semiconductor memory card that is connected to an external device for use, comprising a circuit board that has an input/output terminal to be connected to said external device for signal input/output, an internal terminal and a substrate wiring formed on the upper surface thereof and has a resin member for insulation protection of said substrate wiring; a semiconductor memory chip for storing data that is mounted on the lower surface of said circuit board and electrically connected to said internal terminal; and an insulating seal for insulating said internal terminal from the outside that is disposed on said circuit board to cover at least said internal terminal, wherein the peripheral part of said insulating seal is bonded to a position lower than the height of the upper surface of said resin member.

### BRIEF DESCRIPTION OF THE DRAWINGS

FIG. 1 is a top view showing parts of a semiconductor memory card according to an embodiment 1 of the present invention, which is an aspect of the present invention;

FIG. 2 is a top view showing parts of the semiconductor memory card according to the embodiment 1, which is an aspect of the present invention, with an insulating seal applied thereto;

FIG. 3 is a cross-sectional view of the semiconductor memory card taken along the line A-A in FIG. 2;

FIG. 4 is a cross-sectional view showing a configuration of parts of a semiconductor memory card according to the embodiment 2, which is an aspect of the present invention;

FIG. 5 is a top view showing a configuration of parts of a semiconductor memory card according to the embodiment 3, which is an aspect of the present invention;

FIG. 6 is a cross-sectional view of the semiconductor memory card with an insulating seal bonded thereto taken along the line B-B in FIG. 5; and

FIG. 7 is a cross-sectional view showing a configuration of parts of a semiconductor memory card according to the embodiment 4, which is an aspect of the present invention.

### DETAILED DESCRIPTION

In the following, embodiments of the present invention will be described with reference to the drawings. In the embodiments described below, the present invention is applied to the SD card™ as a semiconductor memory card can be connected to an external terminal of an external device for use.

### EMBODIMENT 1

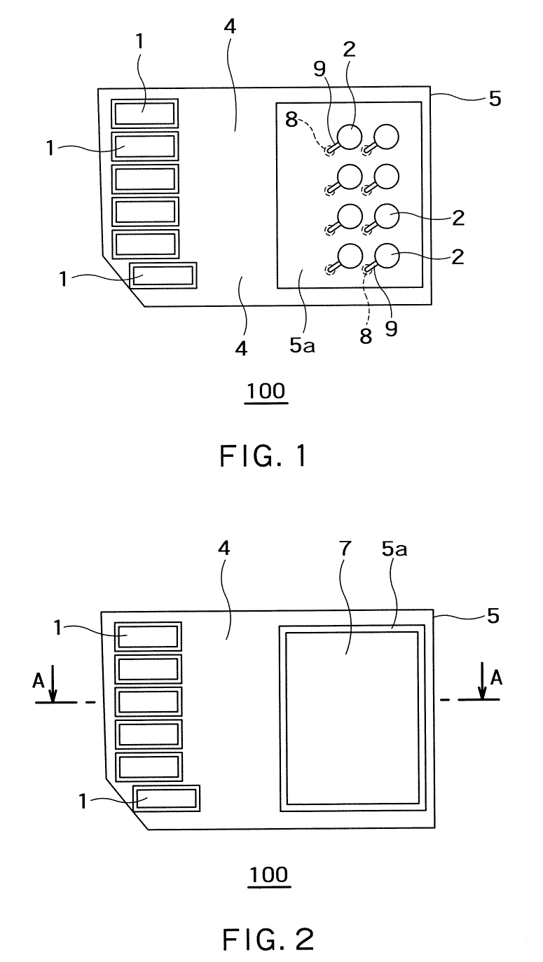

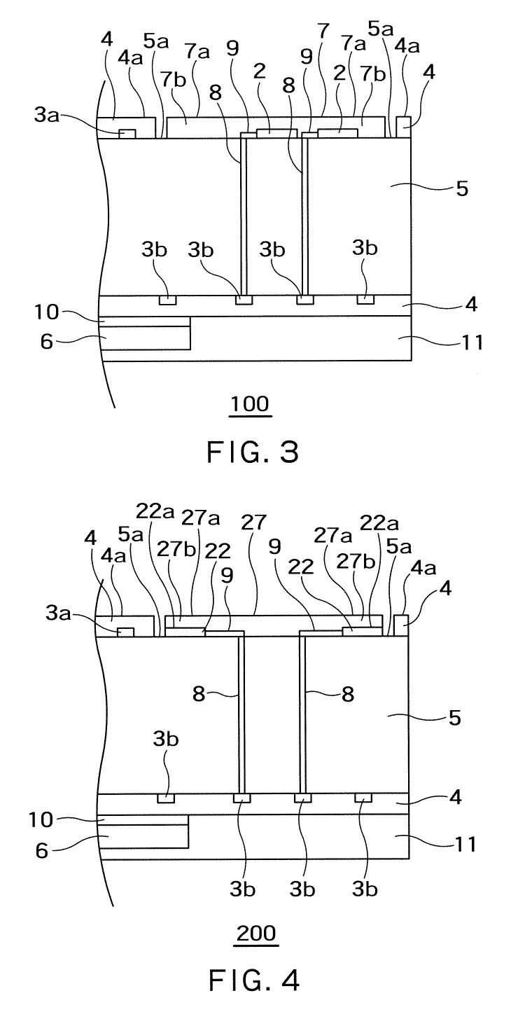

FIG. 1 is a top view showing parts of a semiconductor memory card according to an embodiment 1 of the present invention, which is an aspect of the present invention. FIG. 2 is a top view showing parts of the semiconductor memory card according to the embodiment 1, which is an aspect of the present invention, with an insulating seal applied thereto. FIG. 3 is a cross-sectional view of the semiconductor memory card taken along the line A-A in FIG. 2.

As shown in FIGS. 1 to 3, a semiconductor memory card 100 has: a circuit board 5 that has an input/output terminal 1 to be connected to an external device (not shown) for signal input/output, an internal terminal 2 and board wirings 3a and 3b formed on a surface thereof and has a solder resist 4 made of a resin for insulation and protection of the board wirings 3a and 3b; a semiconductor memory chip 6 for storing desired data that is mounted on the circuit board 5 and electrically connected to the internal terminal 2; and an insulating seal 7 for insulating the internal terminal 2 from the outside that is applied to the circuit board 5 to cover at least the internal terminal 2.

The input/output terminal 1 is plated with gold, for example, to improve contact with the terminal on the external device. Transmission of predetermined data between the semiconductor memory chip 6 and the external device can be started only after the input/output terminal 1 is connected to the external terminal (not shown) on the external device.

In this example, the internal terminal 2 is used by the manufacturer of the semiconductor memory card 100. For example, the manufacturer uses the internal terminal 2 to write a program or the like to the semiconductor memory chip 6 mounted in the assembly step of the semiconductor memory card 100 and to input a signal for testing the mounted semiconductor memory chip 6 for any failure and receive the test signal output therefrom. After these operations by the manufacturer are completed, as described above, the internal terminal 2 is insulated from the outside by the insulating seal 7. In this way, the internal terminal, which is not used by users, is insulated from the outside, thereby preventing malfunction or the like of the semiconductor memory card 100.

The board wiring 3a is connected to the input/output terminal 1, other elements disposed on the upper surface of the circuit board 5, a through-hole connection (not shown) and the like.

The board wiring 3b is connected to the semiconductor memory chip 6 by wire bonding or the like and is connected to other elements on the lower surface of the circuit board 5, a through-hole connection (not shown) and the like.

A through-hole connection 8 electrically connected to the semiconductor memory chip 6 via the board wiring 3b is formed in the circuit board 5 in the area covered with the insulating seal 7. The through-hole connection 8 is connected to the internal terminal 2 via a board wiring 9 that is not covered with the solder resist 4. This allows a desired signal to be input to and output from the semiconductor memory chip 6 via the internal terminal 2. The through-hole connection 8 may be connected to the board wiring 3a formed on the upper surface of the circuit board 5, for example.

The semiconductor memory chip 6 may be a non-volatile semiconductor memory, such as an NAND flash memory. The semiconductor memory chip 6 is bonded to the solder resist 4 on the lower surface of the circuit board 5 by an adhesive layer 10. The semiconductor memory chip 6 is controlled by a controller chip (not shown), stores data input via the input/output terminal 1 or the internal terminal 2, and outputs the stored data via the input/output terminal 1 or the internal terminal 2.

In addition, the semiconductor memory chip 6, which is bonded to the circuit board 5, is sealed with a sealing resin member 11 and insulated from the outside.

The insulating seal 7 may be a resin sheet having a thickness of 20 μm to 150 μm coated with an adhesive. The internal terminal 2 is insulated from the outside by applying the insulating seal 7 to the circuit board 5.

The distance between a peripheral part 7b of the insulating seal 7 and the solder resist 4 may be determined to be 100 μm to 200 μm taking into account the dimensional accuracy and attachment accuracy of the insulating seal 7, for example. As described above, since the board wiring 9 is connected to the through-hole connection 8, the board wiring 9 is not formed in the area of the upper surface 5a of the circuit board 5 that is not covered with the insulating seal 7 and the solder resist 4. Therefore, the board wiring 9 is not exposed, so that any unwanted signal can be prevented from being input through the board wiring 9.

In addition, the peripheral part 7b of the insulating seal 7 is bonded to a position lower than the height of an upper surface 4a of the solder resist 4. In this example, at least the peripheral part 7b of the insulating seal 7 is bonded to the upper surface 5a of the circuit board 5. That is, the height of the peripheral part 7b of the insulating film 7 is lower than that in the case where the insulating seal 7 is bonded to the solder resist 4. As a result, the peripheral part 7b of the insulating seal 7 is less likely to catch on the external device or the like when the peripheral part 7b comes into contact with the external device or the like, stress is prevented from being concentrated at the bonded part, and thus, the insulating seal 7 is prevented from peeling off.

Furthermore, if the height of an upper surface 7a of the peripheral part of the insulating seal 7 is adjusted to be equal to or lower than the height of the upper surface 4a of the solder resist 4, the possibility that the peripheral part 7b of the insulating seal 7 catches on the external device or the like can be further reduced. In this example, for example, if the insulating seal 7 has a thickness of 100 μm, the solder resist 4 is formed on the circuit board 5 to have a thickness of 100 μm or more.

As described above, in the semiconductor memory card according to this embodiment, the peripheral part of the insulating seal is bonded to the upper surface of the circuit board, thereby lowering the height of the insulating seal, thereby preventing the insulating seal from peeling off. Thus, the internal terminals are prevented form coming into contact with a terminal on an external device or the like, so that an unwanted signal is prevented from being input to the internal terminal. Therefore, malfunction of the semiconductor memory card is avoided, and the reliability thereof is improved.

### EMBODIMENT 2

With regard to the embodiment 1, a configuration has been described in which the peripheral part of the insulating seal is bonded to the upper surface of the circuit board, thereby lowering the height of the insulating film.

However, with regard to an embodiment 2, a configuration will be described in which a peripheral part of an insulating seal is bonded to an upper surface of an internal terminal, thereby lowering the height of the insulating seal.

FIG. 4 is a cross-sectional view showing a configuration of parts of a semiconductor memory card 200 according to the embodiment 2, which is an aspect of the present invention. In this drawing, the same reference numerals as in the embodiment 1 denote the same elements as in the embodiment 1.

As shown in FIG. 4, an internal terminal 22 are disposed along the periphery of an area to be covered. In addition, an insulating seal 27 is disposed on a circuit board 5 to cover the internal terminal 22. At least a peripheral part 27b of the insulating seal 27 is bonded to an upper surface 22a of the internal terminal 22.

Here, the height of an upper surface 4a of a solder resist 4 is set to be higher than that of the upper surface 22a of the internal terminal 22. That is, the height of the peripheral part 27b of the insulating seal 27 is lower than that in the case where the insulating seal 27 is bonded to the solder resist 4. As a result, the peripheral part 27b of the insulating seal 27 is less likely to catch on the external device or the like when the peripheral part 27b comes into contact with the external device or the like, stress is prevented from being concentrated at the bonded part, and thus, the insulating seal 27 is prevented from peeling off.

Furthermore, if the height of an upper surface 27a of the peripheral part 27b of the insulating seal 27 is adjusted to be equal to or lower than the height of the upper surface 4a of the solder resist 4, the possibility that the peripheral part 27b of the insulating seal 27 catches on the external device or the like can be further reduced.

If a plurality of internal terminals 22 spaced apart from each other are disposed, the peripheral part 27b of the insulating seal 27 over the spaces between the internal terminals 22 may be bonded to the upper surface 5a of the circuit board 5.

As described above, in the semiconductor memory card according to this embodiment, the peripheral part of the insulating seal is bonded to the upper surface of the internal terminal 2, thereby lowering the height of the insulating seal, thereby preventing the insulating seal from peeling off. Thus, the internal terminals are prevented form coming into contact with a terminal on an external device or the like, so that an unwanted signal is prevented from being input to the internal terminal. Therefore, malfunction of the semiconductor memory card is avoided, and the reliability thereof is improved.

### EMBODIMENT 3

With regard to the embodiments 1 and 2, configurations have been described that have the board wiring connecting the internal terminal and the through-hole connection to each other.

However, the internal terminal and the through-hole connection may be directly connected to each other to prevent the board wiring form being exposed in the area of the circuit board that is not covered with the insulating seal.

With regard to an embodiment 3, a configuration will be described in which an internal terminal and a through-hole connection are directly connected to each other.

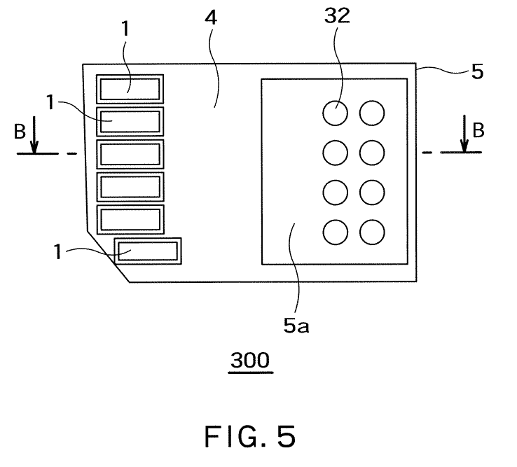

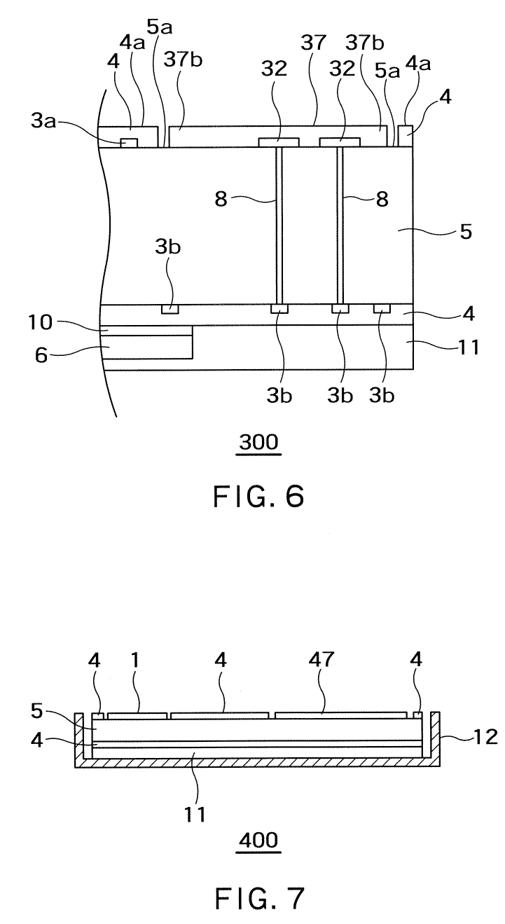

FIG. 5 is a top view showing a configuration of parts of a semiconductor memory card according to the embodiment 3, which is an aspect of the present invention. FIG. 6 is a cross-sectional view of the semiconductor memory card with an insulating seal bonded thereto taken along the line B-B in FIG. 5. In these drawings, the same reference numerals as in the embodiment 1 denote the same elements as in the embodiment 1.

As shown in FIG. 5 and FIG. 6, an internal terminal 32 is connected to a board wiring 3b on the bottom of a circuit board 5 via a through-hole connection 8. Furthermore, the internal terminal 32 may be connected to a board wiring 3a on the upper surface of the circuit board 5 via a through-hole connection.

At least a peripheral part 37b of an insulating seal 37 is bonded to the upper surface 5a of the circuit board 5. That is, the height of the peripheral part 37b of the insulating seal 37 is lower than that in the case where the insulating seal is applied to a solder resist 4. Thus, as in the embodiment 1, the insulating seal 37 can be prevented from peeling off.

Furthermore, if the height of an upper surface 37a of the peripheral part of the insulating seal 37 is adjusted to be equal to or lower than the height of an upper surface 4a of the solder resist 4, the possibility that the peripheral part 37b of the insulating seal 37 catches on the external device or the like can be further reduced.

As described above, in the semiconductor memory card according to this embodiment, the peripheral part of the insulating seal is bonded to the upper surface of the circuit board, thereby lowering the height of the insulating seal, thereby preventing the insulating seal from peeling off. Thus, the internal terminals are prevented form coming into contact with a terminal on an external device or the like, so that an unwanted signal is prevented from being input to the internal terminal. Therefore, malfunction of the semiconductor memory card is avoided, and the reliability thereof is improved.

### EMBODIMENT 4

With regard to the embodiments 1 to 3, configurations have been described in which the circuit board, on which the semiconductor memory chip is mounted, constitutes the exterior of the semiconductor memory card.

However, the structures according to the embodiments 1 to 3 may be housed in a cover case.

With regard to an embodiment 4, a configuration will be described in which a circuit board is housed in a cover case.

FIG. 7 is a cross-sectional view showing a configuration of parts of a semiconductor memory card according to the embodiment 4, which is an aspect of the present invention. In this drawing, the same reference numerals as in the embodiment 1 denote the same elements as in the embodiment 1.

As shown in FIG. 7, a semiconductor memory card 400 has: a cover case 12 that is made of a resin and is open at the top; a circuit board 5 that is mounted in the cover case 12 and has an input/output terminal 1 formed on a surface thereof and a solder resist 4 made of a resin for insulation protection of a board wiring; a sealing resin member 11 that seals a semiconductor memory chip mounted on the circuit board 5; and an insulating seal 47 disposed on the circuit board 5 to cover at least an internal terminal to insulate the internal terminal from the outside.

The cover case 12 and the sealing resin member 11 are bonded to each other by an adhesive. Since the circuit board 5 is housed in the cover case 12 in this way, the insulation and the resistance to impact or the like of the semiconductor memory card 400 can be improved.

As described above, the semiconductor memory card according to this embodiment can provide the same effects and advantages as those according to the embodiments 1 to 3, and the reliability can be further improved.

In the embodiments described above, the semiconductor memory chip is disposed on the lower surface of the circuit board. However, the semiconductor memory chip may be disposed on the upper surface or on both the lower and upper surfaces.

In addition, in the embodiments described above, there is provided a desired distance between the solder resist (resin) and the insulating seal taking into account the attachment accuracy or the like. However, the distance may be reduced, or the edge of the solder resist may be brought into contact with the edge of the insulating seal.

What is claimed is:

1. A semiconductor memory card that is connected to an external device for use, comprising:
a circuit board that has an input/output terminal to be connected to said external device for signal input/output, an internal terminal and a substrate wiring formed on the upper surface thereof and has a resin member for insulation protection of said substrate wiring;
a semiconductor memory chip for storing data that is mounted on the lower surface of said circuit board and electrically connected to said internal terminal; and
an insulating seal for insulating said internal terminal from the outside that is disposed on said circuit board to cover at least said internal terminal,
wherein the peripheral part of said insulating seal is bonded to a position lower than the height of the upper surface of said resin member.

2. The semiconductor memory card according to claim 1, wherein at least the peripheral part of said insulating seal is bonded to the upper surface of said circuit board.

3. The semiconductor memory card according to claim 1, wherein at least the peripheral part of said insulating seal is bonded to the upper surface of said internal terminal.

4. The semiconductor memory card according to claim 1, wherein the height of the upper surface of the peripheral part of said insulating seal is equal to or lower than the height of the upper surface of said resin member.

5. The semiconductor memory card according to claim 2, wherein the height of the upper surface of the peripheral part of said insulating seal is equal to or lower than the height of the upper surface of said resin member.

6. The semiconductor memory card according to claim 3, wherein the height of the upper surface of the peripheral part of said insulating seal is equal to or lower than the height of the upper surface of said resin member.

7. The semiconductor memory card according to claim 1, wherein a through-hole connection electrically connected to said semiconductor memory chip is formed in said circuit board in the area thereof covered with said insulating seal, and
said internal terminal is connected to said through-hole connection.

8. The semiconductor memory card according to claim 2, wherein a through-hole connection electrically connected to said semiconductor memory chip is formed in said circuit board in the area thereof covered with said insulating seal, and
said internal terminal is connected to said through-hole connection.

9. The semiconductor memory card according to claim 3, wherein a through-hole connection electrically connected to said semiconductor memory chip is formed in said circuit board in the area thereof covered with said insulating seal, and
said internal terminal is connected to said through-hole connection.

10. The semiconductor memory card according to claim 4, wherein a through-hole connection electrically connected to said semiconductor memory chip is formed in said circuit board in the area thereof covered with said insulating seal, and
said internal terminal is connected to said through-hole connection.

11. The semiconductor memory card according to claim 1, wherein an edge of said resin member and an edge of said insulating seal are in contact with each other.

12. The semiconductor memory card according to claim 1, further comprising:
a cover case for housing said circuit board.
